(19) United States
(12) Patent Application Publication
(10) Pub. No.: US 2018/0006314 A1
(43) Pub. Date: Jan. 4, 2018

(54) BIPOLAR PLATE FOR BATTERY AND REDOX FLOW BATTERY OR FUEL CELL HAVING THE SAME

(71) Applicant: Standard Energy Co., Ltd., Daejeon (KR)

(72) Inventors: Bu Gi KIM, Daejeon (KR); Bumhee CHO, Daejeon (KR); Ki Hyun KIM, Daejeon (KR); Damdam CHOI, Daejeon (KR); Won Tae KIM, Daejeon (KR); Sujeong LEE, Daejeon (KR); Kangyeong CHOE, Daejeon (KR); Jung Hoon KIM, Daejeon (KR); Da Young KIM, Daejeon (KR)

(73) Assignee: Standard Energy Co., Ltd., Daejeon (KR)

(21) Appl. No.: 15/409,295

(22) Filed: Jan. 18, 2017

(30) Foreign Application Priority Data
Jun. 30, 2016 (KR) 10-2016-0082903

(51) Int. Cl. H01M 8/0297; H01M 8/18; H01M 8/0247

(52) U.S. Cl. CPC H01M 8/0297; H01M 8/0247; H01M 8/188

(57) ABSTRACT

Embodiments provide a bipolar plate for a battery, which can enhance battery efficiency by reducing a contact resistance in contact with an electrode, and a redox flow battery having the same are provided. According to at least one embodiment, there is provided a bipolar plate including a thermoplastic portion formed on at least a part thereof to be brought into contact with an electrode and having conductivity, wherein the thermoplastic portion having the conductivity is morphologically matched with the electrode.

### CROSS REFERENCE TO RELATED APPLICATION

This application claims the benefit of and priority to Korean Patent Application Serial No. 10-2016-0082903, filed on Jun. 30, 2016, entitled (translation), “BIPOLAR PLATE FOR BATTERY AND REDOX FLOW BATTERY OR FUEL CELL HAVING THE SAME,” which is hereby incorporated by reference in its entirety into this application.

### BACKGROUND

### Field

Embodiments relate generally to a bipolar plate for a battery and a redox flow battery or a fuel cell having the same, and more particularly, to a bipolar plate for a battery, which can enhance battery efficiency by reducing a contact resistance in contact with an electrode, and a redox flow battery or a fuel cell having the same.

### Description of the Related Art

Due to environmental pollution and global warming, an effort to globally reduce greenhouse gas is ongoing. For example, various efforts such as expansion of introduction of new regeneration energy, development of eco-friendly cars, or development of a power storage system for enhancing a power supply and demand system are being made.

Most of the power supply systems are based on thermal power generation, but the thermal power generation uses fossil fuel and emits huge amounts of carbon dioxide, and thus causes very serious environmental pollution problems. To solve these problems, there is an increasing demand for development of a power supply system using green energy (wind power, solar energy, tidal power, or the like).

Since most new regeneration energy uses clean energy generated from nature, it is useful in that it does not emit exhaust fumes related to environmental pollution, but, since the new regeneration energy is much influenced by natural environment, the output of energy widely fluctuates with time and there is a limitation to using it.

Technology of storing power is important for efficient use of total energy, such as efficient use of power, enhanced capability or reliability of a power supply system, expansion of introduction of new regeneration energy which has the wide range of fluctuation with time, and the possibility of development thereof and the demand for contribution to society are increasing. In particular, expectations for a fuel cell and utilization of the fuel cell in this field are increasing.

A redox flow battery and a fuel cell differ from each other in their components, but similarly function of charging, discharging, or generating electricity by an electrochemical reaction of a reactant in a cell provided with certain components.

The redox flow battery includes core components, such as an electrode, an electrolyte, a membrane, and a bipolar plate. The bipolar plate is a component, which serves to perform a key role, such as conducting, applying, discharging, and separating electricity in a corresponding energy device. In addition, a bipolar plate of a carbon group material is normally used for the bipolar plate, but researches on a bipolar plate of new material substituting for the carbon group material due to low machinability, a high volume share, and low mechanical strength of the carbon group bipolar plate.

The fuel cell converts chemical energy into electric energy by using an oxidation-reduction reaction of hydrogen and oxygen. Hydrogen is oxidized at an anode and is divided into hydrogen ions and electrons. The hydrogen ions move to a cathode through the electrolyte. In addition, the electrons move to the anode through a circuit. The hydrogen ions, electrons, and oxygen react in the anode and reduction reaction is caused to make water.

In the redox flow battery, the bipolar plate is important in terms of mechanical material properties such as strength sufficient to support an electrode formed of a porous material and prevent deformation, impermeableness for the electrolyte, or the like, and electrochemical material properties such as carrying a reaction gas and collecting and transmitting generated electricity. In particular, the electrical conductivity of the bipolar plate related to the electrochemical material properties and the contact resistance between the bipolar plate and the electrode are very important to the power efficiency of the battery.

Korean Patent Publication No. 2015-0057562 (titled “Redox Flow Type Secondary Battery Bipolar Plate and Manufacturing Method Thereof) discloses a method for manufacturing a secondary battery bipolar plate, including the steps of: forming an Ni—P plating layer on one side of a metal base; and forming a carbon coating layer by coating the Ni—P plating layer with carbon. However, the carbon coating layer may be eroded and removed due to a reactant when the battery is driven and there is a problem that the lifespan of the battery is reduced.

Korean Patent Registration No. 10-1262600 (titled “Iron-Nickel/Chrome-Carbon Nano Tube Metal Bipolar Plate for Fuel Cell, and Manufacturing Method Thereof”) relates to a Fe—Ni/Cr-CNT metal bipolar plate which has complex channels thereof integrally molded with one another by a horizontal electro-forming technique, and thus good strength, hardness, durability, corrosion resistance, and/or electrical conductivity, and a manufacturing method thereof. The method for manufacturing the Fe—Ni/Cr-CNT metal bipolar plate for a fuel cell includes the steps of: supplying an electrolyte including an iron precursor and a nickel precursor to the surface of a Fe—Ni/Cr-CNT metal bipolar plate, which includes an Fe—Ni alloy thin film and a Cr-CNT layer formed on both surfaces of the Fe—Ni alloy thin film, and which has channels formed therein for a fuel cell, and to the surface of a conductive substrate in which channels of the bipolar plate for the fuel cell horizontally supplied in a predetermined direction are formed; applying an electric current to the substrate which acts with as an anode electrode and a cathode electrode spaced from the surface of the substrate in which the channels for the bipolar plate for the fuel cell are formed, such that the iron and the nickel are electrodeposited onto the surface of the conductive substrate; separating an Fe—Ni alloy electrodeposition layer which is formed by electrodepositing the iron and the nickel; and forming a Cr-CNT layer on both surfaces of the Fe—Ni alloy thin film which is obtained by removing the Fe—Ni alloy electrodeposition layer.

Korean Patent Publication No. 2012-0122090 (titled “Electroless Nickel-Phosphorus Plating Liquid for Fuel Cell Bipolar Plate and Fuel Cell Bipolar Plate”) discloses an electroless Ni—P plating liquid for a fuel cell bipolar plate, including a nickel precursor; and a reducing agent, wherein the reducing agent provides the electroless Ni—P plating liquid for the fuel cell bipolar plate including sodium hypophosphite and hydrazine. In addition, the present invention discloses a fuel cell bipolar plate including a metal substrate; and an Ni—P plating layer formed on the metal substrate, wherein the Ni—P plating layer includes 3.0 to 6.0 parts by weight of phosphorous (P) with reference to weight of added nickel (Ni) and phosphorous (P).

However, there is still a demand for development of a bipolar plate which can realize a low contact resistance with an electrode while maintaining high mechanical strength and chemical stability.

### SUMMARY

To address the previously discussed deficiencies of the conventional art, an embodiment of the present invention reduces a contact resistance by morphologically matching the surface of a bipolar plate satisfying a mechanical material property with an electrode which is brought into contact with the bipolar plate.

According to at least one embodiment, there is provided a bipolar plate for a battery, including a thermoplastic portion formed on at least a part thereof to be brought into contact with an electrode and having conductivity. The thermoplastic portion having the conductivity is morphologically matched with the electrode, such that the bipolar plate and the electrode have shapes to be matched with each other in appearance.

According to at least one embodiment, there is provided a stack, including at least one unit cell, including the bipolar plate according to various embodiments, wherein the bipolar plate includes the thermoplastic portion formed on the at least a part thereof to be brought into contact with the electrode and having the conductivity, and wherein the electrode is to be brought into contact with the bipolar plate, is stacked and assembled, and the thermoplastic portion is morphologically matched with the electrode by applying an electric current to the bipolar plate in the assembled state.

According to at least one embodiment, the thermoplastic portion having the conductivity is a resin comprising a conductive material.

According to at least one embodiment, the resin is a thermoplastic resin having a softening point or a melting point of 41° C. or higher.

According to at least one embodiment, the bipolar plate comprises only the thermoplastic portion having the conductivity.

According to at least one embodiment, the bipolar plate is formed of a plate and further includes a plate-type thermoplastic portion having conductivity.

According to at least one embodiment, the plate is a conductive plate.

According to at least one embodiment, the conductive plate is a metal plate.

According to at least one embodiment, the electrode is formed of a porous material.

According to at least one embodiment, electrode is a non-woven fabric of a conductive fiber.

According to at least one embodiment, there is provided a redox flow battery or a fuel cell, including a plurality of bipolar plates, each of which includes a thermoplastic portion formed on at least a part thereof to be brought into contact with an electrode, and having conductivity, where the thermoplastic portion having the conductivity being morphologically matched with the electrode. The redox flow battery or the fuel cell includes a plurality of electrodes, which are interposed between the bipolar plates and fixed, an electrolyte which passes through the electrode, and a membrane which is interposed between the electrodes to allow ions to pass therethrough.

According to at least one embodiment, the bipolar plate is formed by impregnating a porous conductive material with a thermoplastic resin.

According to at least one embodiment, the porous conductive material forms a porous conductive structure by compressing metal powder under a predetermined pressure or compressing carbon (or graphite) powder under a predetermined pressure, or forms by using activated carbon.

### BRIEF DESCRIPTION OF THE DRAWINGS

The patent of application file contains at least one drawing executed in color. Copies of this patent or patent application publication with color drawing will be provided by the office upon request and payment of the necessary fee.

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a view schematically showing a configuration of a redox flow battery.

FIG. 2 is an exploded perspective view schematically showing a unit cell constituting the redox flow battery.

FIG. 3 is a view showing one method for morphologically matching a bipolar plate constituting a unit cell and an electrode with each other to reduce a contact resistance therebetween according to an embodiment.

FIG. 4 is a side cross section view of FIG. 3.

FIG. 5 is a view showing another method for morphologically matching a bipolar plate constituting a unit cell and an electrode with each other to reduce a contact resistance therebetween according to another embodiment.

FIG. 6 is a view showing another method for morphologically matching a thermoplastic portion of a bipolar plate and an electrode by applying an electric current to the bipolar plate in a state in which a stack including at least one unit cell is assembled according to another embodiment.

FIG. 7 is a view schematically showing the bipolar plate and the electrode, which are matched with each other.

### DETAILED DESCRIPTION

Although the following detailed description contains many specific details for purposes of illustration, it is understood that one of ordinary skill in the relevant art will appreciate that many examples, variations, and alterations to the following details are within the scope and spirit of the invention. Accordingly, the exemplary embodiments of the invention described herein are set forth without any loss of generality, and without imposing limitations, relating to the claimed invention. Like numbers refer to like elements throughout. Prime notation, if used, indicates similar elements in alternative embodiments.

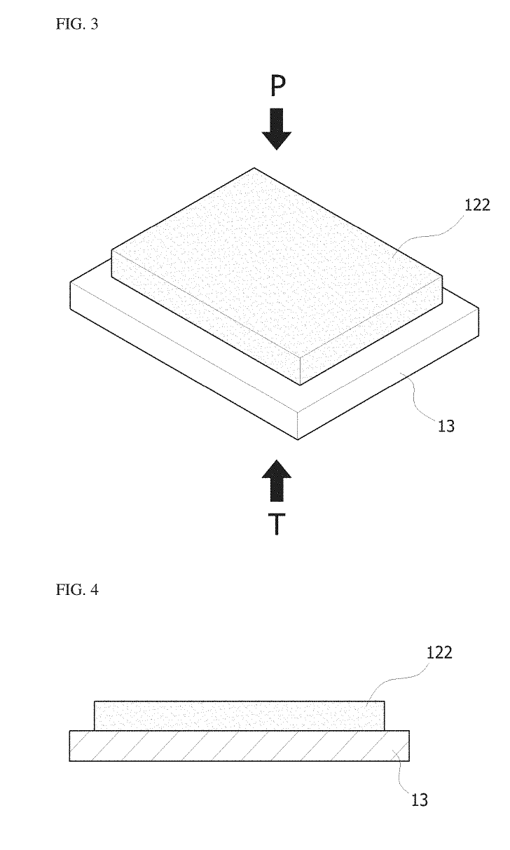

As shown in FIG. 3, a bipolar plate 13 for a battery according to various embodiments may include a thermoplastic portion formed on at least a part thereof to be brought into contact with an electrode 122 and having conductivity, and the thermoplastic portion having the conductivity may be morphologically matched with the electrode 122. FIG. 3 illustrates a case in which the entirety of the bipolar plate 13 is formed of the thermoplastic portion having the conductivity, but it should be understood that a part of the bipolar plate 13 may be formed of the thermoplastic portion having the conductivity.

The term “conductivity” refers to “electrical conductivity” and it should be understood that these terms are interchangeably used in the following description unless otherwise specified.

The term “morphologically matching” refers to “matching in terms of a form,” that is, “matching in terms of the way something looks,” that is, “matching in appearance.” Specifically, this term indicates that the bipolar plate 13 and the electrode 122, which are brought into contact with each other, have forms to be matched with each other in appearance, such that the bipolar plate 13 and the electrode 122 are brought into surface contact with each other and thereby reduce a contact resistance therebetween.

The term “contact resistance” refers to a resistance, which exists in a mechanical contact portion of a conductor. When the contact portion is not brought into surface contact and is brought into contact with some protrusions, the contact resistance means to a convergence resistance, which is generated as cables of an electric current are collected at the contact portion, or a resistance which is generated due to an insulating film generated on the contact portion and other contamination. For example, the contact resistance refers to an electric resistance of the contact portion like a brush, a commutator, a blade a knife switch, and a clip.

Accordingly, embodiments provide that the bipolar plate 13 and the electrode 122 are morphologically matched with each other, such that the contact resistance therebetween is reduced. To achieve this feature, according to various embodiments, the bipolar plate 13 includes the thermoplastic portion formed on at least a part thereof to be brought into contact with the electrode 122 and having the conductivity, and the bipolar plate 13 and the electrode 122 are morphologically matched with each other by applying heat to the thermoplastic portion having the conductivity.

The term “thermoplastic portion” refers to a portion, which has plasticity when heat is applied, that is, has the property of being melted or having its shape changed. Accordingly, the thermoplastic portion having the conductivity may be a resin including a conductive material, and the thermoplastic resin may include the conductive material, preferably, one or more selected from the group consisting of: a fibrous or particulate metal; a fibrous or particulate metallic oxide; and a fibrous or particulate carbon material. However, the embodiments are not limited to the above-listed conductive material and it should be understood that any conductive material showing conductivity can be used.

According to at least one embodiment, the resin may be a thermoplastic resin which has a softening point or a melting point of 41° C. or higher, preferably 42° C. to 250° C., more preferably 43° C. to 100° C., most preferably 45° C. to 70° C. The softening point refers to a temperature, which is lower than the melting point and at which a material can be softened and thus can be easily deformed by a small external force. The softening point may be referred to as “glass transition temperature.” These terms are interchangeably used. When the softening point is less than 41° C., it may be easy to morphologically match the bipolar plate 13 and the electrode 122 by heat (T), but the bipolar plate 13 and the electrode 122 may be deformed by heat, which may be generated when the battery is driven after being assembled and thus a connection state between the bipolar plate 13 and the electrode 122 may be changed. Thus, there is a problem that the reliability deteriorates. To the contrary, when the softening point exceeds 250° C., the bipolar plate 13 may include heat, which may be generated when the battery is driven after being assembled, and externally applied heat, and thus the bipolar plate 13 is less likely to be deformed by heat and the reliability of the battery increases. However, in this case, it may be difficult to morphologically match the bipolar plate 13 and the electrode 122 with each other by heat, and also, a high pressure (P) should be applied in order to morphologically match the bipolar plate 13 and the electrode 122 when they are less softened. As a result, an excessive pressure is applied to the electrode 122, in particular formed of a porous material, and accordingly, there may be a problem that the performance of the battery deteriorates due to the deformation of the electrode 122 formed of the porous material or the deformation of pores. There is no limitation to the method of applying heat to the thermoplastic portion having the conductivity to be softened in order to morphologically match the bipolar plate 13 and the electrode 122. However, it is preferable that the thermoplastic portion having the conductivity is heated by so-called Joule's heat by applying an electric current to the thermoplastic portion in close contact with the electrode 122. In this case, since the degree of heating is in proportion to the resistance of the conductive thermoplastic portion and the amount of applied electric current, it is possible to minutely control the thermoplastic portion within the range of the above-mentioned softening point, and also, there is an advantage that pollution from a heat source supplying heat for heating can be avoided. In addition, the matching between the bipolar plate 13 and the electrode 122 can be facilitated by applying a mechanical pressure (P) at the same as heating.

According to at least one embodiment, the bipolar plate 13 may include only the thermoplastic portion having the conductivity as shown in FIG. 4. That is, the entirety of the bipolar plate 13 may be formed of a resin including a conductive material. This makes it easy to manufacture the bipolar plate 13. In addition, since the bipolar plate 13 has its own thermoplasticity, there is no or less possibility that other contact resistances except the contact resistance with the electrode 122, brought into contact with the bipolar plate 13, are generated, and thus it is possible to manufacture the bipolar plate 13 having good electric characteristics.

According to at least one embodiment, there is provided a fuel cell, which includes a membrane-electrode assembly (MEA) in which an electrochemical reaction occurs; an electrode which is formed of a porous medium for evenly dispersing an electrolyte over the surface of the membrane-electrode assembly (MEA); and a bipolar plate which supports the membrane-electrode assembly (MEA) and the electrode formed of the porous medium, and which carries the electrolyte and collects and transmits generated electricity. Therefore, the bipolar plate should have enhanced corrosion resistance and mechanical strength. The bipolar plate may use a metal plate such as an SUS alloy for the sake of electrical conductivity. In addition, the metal plate may be formed of a thin film for the sake of lightness, and a Ni—P (nickel-phosphorus) plating layer may be formed on the surface of the metal plate of the thin film, such that the mechanical strength can be enhanced. In addition, basic thermal conductivity and electrical conductivity can be ensured by the Ni—P plating, and also, by forming a carbon layer on the Ni—P plating layer, the thermal conductivity and the electrical conductivity can be reinforced with the corrosion resistance.

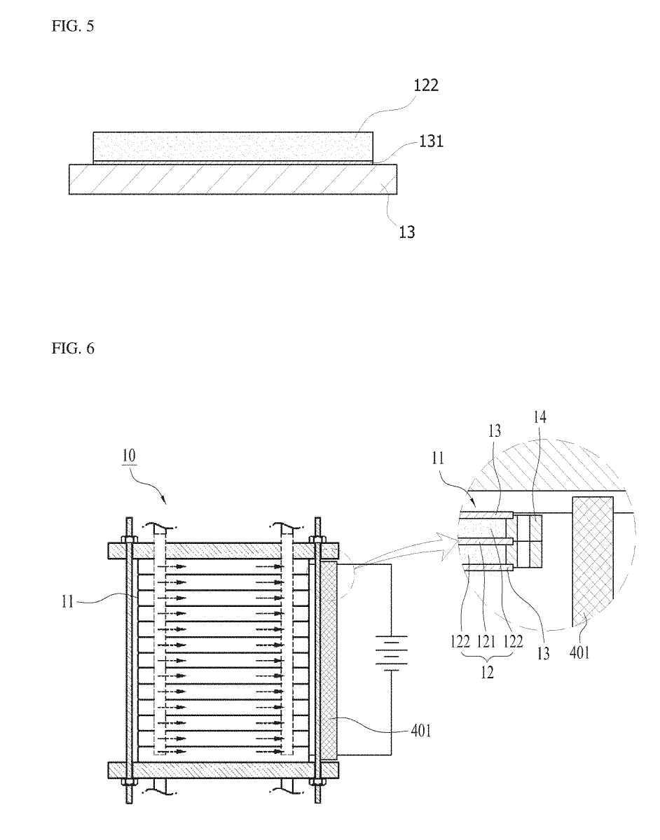

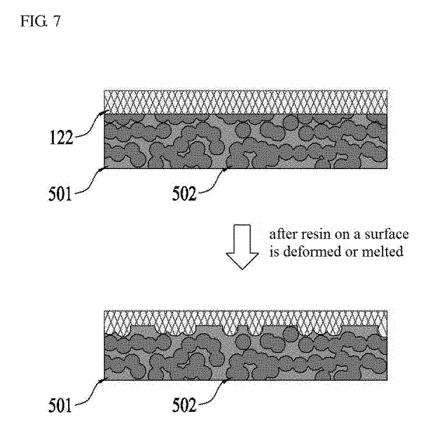

According to at least one embodiment, as shown in FIG. 5, the bipolar plate 13 may be formed of a plate and may further include a plate type thermoplastic portion 131 having conductivity. The plate may be surrounded by the thermoplastic portion having the conductivity, and in this case, the plate may use any one of a conductor or a non-conductor since the conductivity of the plate rarely influences the electric characteristic of the conductive bipolar plate 13 due to the characteristic of the electric current flowing along a surface. According to at least one embodiment, the bipolar plate 13 may be formed by impregnating a conductive material 501 formed of a porous structure (porous conductive material) with a thermoplastic resin 502 having a softening point or a melting point exceeding 41° C. in advance, as shown in FIG. 7. When heat is applied to such a bipolar plate 13 as shown in FIG. 7, a part of the thermoplastic resin formed on the surface of the bipolar plate 13, which is in contact with the electrode 122 may be deformed or melted and a part of the electrode is brought into contact with the pores on the surface of the bipolar plate 13, such that the contact resistance can be reduced. More specifically, the porous conductive material 501 may form a porous conductive structure by compressing metal powder under a predetermined pressure, or by compressing carbon (or graphite) powder under a predetermined pressure, or may use a porous conductive structure such as activated carbon.

On the other hand, as shown in FIG. 5, the plate may be formed in a plate shape and may be fixed to one side of the plate type thermoplastic portion 131 having the conductivity. In this case, preferably, the plate may be a conductive plate having conductivity, and more preferably, may be a metal plate which is an electric conductor. It is preferable that the plate is a conductor since the flow of an electric current is in a stack direction of a unit cell when the battery is charged or discharged.

Accordingly, the previously described configuration makes it possible to provide the bipolar plate 13 having high electrical conductivity, excellent chemical resistance, and high mechanical strength and toughness, and in particular, the efficiency of the battery can be enhanced by reducing the contact resistance with the electrode 122.

According to at least one embodiment, the electrode 122, which is in contact with the bipolar plate 13 may be made of a porous material, in particular, a nonwoven fabric of a conductive fiber, such as a carbon fiber.

According to at least one embodiment, the electrode 122 may be formed of a porous material, in particular, a porous material which is an electric conductor, such that a reactant can easily pass through the pores of the electrode 122. When the reactant passes through the electrode 122, ions may be exchanged through an ion-exchange membrane interposed between the electrodes 122 and an electrochemical reaction occurs, such that charging and discharging are performed.

In particular, embodiments are effective in reducing the contact resistance by bringing the electrode 122 into contact with the bipolar plate 13, which has the thermoplastic portion which is deformed according to the shape of the electrode 122 formed of the porous material, in particular, the shape of the outer surface of the electrode 122, and is brought into close contact. Since the appearance of the electrode 122 formed of the porous material is irregular and varies from electrode to electrode, the contact resistance between the bipolar plate 13 and the electrode 122 may not be effectively reduced by simply processing the surface of the bipolar plate 13 to have a regular concave-convex portion in a related-art method. However, according to various embodiments, a contact area between the bipolar plate 13 and the electrode 122 can be maximized by bringing the bipolar plate 13 into contact with the electrode 122, and deforming the thermoplastic portion of the bipolar plate 13 according to the appearance of the electrode 122, which is brought into contact with the bipolar plate 13, that is, matching, by applying heat, and accordingly, the contact resistance can be minimized Therefore, the method of various embodiments is more effective in reducing the contact resistance. In addition, since the process of matching the bipolar plate 13 and the electrode 122 with each other may be performed before or after a stack is assembled, there is an advantage that stack assembly efficiency can be greatly enhanced. FIG. 6 illustrates electrode matching which is performed after a stack is assembled, and illustrates that a thermoplastic portion is morphologically matched with an electrode by applying an electric current to a bipolar plate in a state in which a stack including at least one unit cell is assembled. In this case, a power source for supplying an electric current to the bipolar plate of the unit cell may be temporarily brought into contact with a side surface of the bipolar plate through an electrode connection part 401 and may supply power, thereby generating Joule's heat.

When the bipolar plate 13 and the electrode 122 are compressed under a predetermined pressure after the stack is assembled, and Joule's heat is generated by applying extra electricity to the bipolar plate, the matching can be efficiently performed. In this case, it is preferable to bring the separate power source and the electrode 122 into contact with the bipolar plate 13 in order to supply extra electricity to the bipolar plate 13 from the outside, and it is preferable to supply an electric current to heat the bipolar plate 13 sufficiently. In addition, it is preferable that a part of the bipolar plate 13 is exposed to be brought into contact with the external power source and the electrode 122 after the stack is assembled.

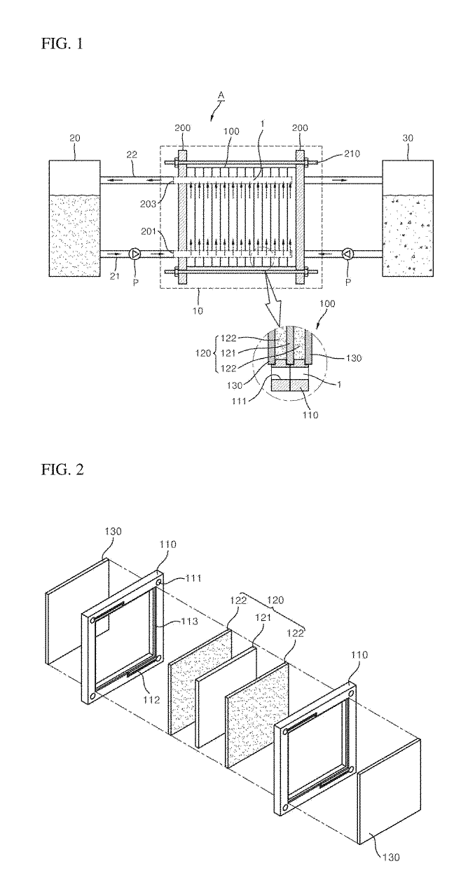

As shown in FIG. 1, a redox flow battery according to at least one embodiment includes a plurality of bipolar plates 13 having a thermoplastic portion formed on at least a part thereof to be brought into contact with an electrode 122 and having conductivity, the thermoplastic portion having the conductivity being morphologically matched with the electrode 122; a plurality of electrodes 122, which are interposed between the bipolar plates 13 and fixed; an electrolyte passing through the electrode 122; and a membrane which is interposed between the electrodes 122 to allow ions to pass therethrough, and is characterized in that electrical efficiency can be enhanced by reducing a contact resistance between the bipolar plate 13 and the electrode 122. As shown in FIGS. 1 and 2, the redox flow battery may include an anode reactant storage tank 20 for storing an anode electrolyte and a cathode reactant storage tank 30 for storing a cathode electrolyte, and a stack 10 in which the electrolytes are circulated. In this case, the stack 10 has a plurality of unit cells 11 stacked one on another, each of which is a minimum component for causing an electrochemical reaction, and the unit cell 11 includes a membrane-electrode assembly 12 in which an ion-exchange membrane 121 is stacked between two electrodes 122, and the bipolar plate 13. In addition, a frame 14 provided with a channel for maintaining the shape of the cell 11 and guiding the flow of the reactant may be used therewith. Herein, the membrane-electrode assembly 12 may refer to an assembly having a membrane and an electrode connected with each other, and may include an integrated structure of the membrane and the electrode adhering to each other, as well as a separable type.

In addition, in describing the various embodiments, the redox flow battery has been described by way of an example, but the various embodiments may be applied to a fuel cell for the same purpose. This is because both the redox flow battery and the fuel cell use a stack having a plurality of unit cells stacked one on another, and the structures of the unit cells are similar. However, there is a difference in that the redox flow battery uses an electrolyte as a reactant, whereas the fuel cell uses anode and cathode fuels (hydrogen and oxygen in the case of a PEM fuel cell). However, since the redox flow battery and the fuel cell have the same flow of the reactant and the same structure of the stack, the various embodiments are equally applied to the redox flow battery and the fuel cell. Accordingly, in describing the present disclosure, embodiments applied to the fuel cell are omitted.

Hereinafter, preferred examples and comparison examples of the various embodiments will be described.

The following examples are merely to describe the various embodiments and should not be understood as limiting the scope.

### Example 1

The bipolar plate 13 was manufactured by using a thermoplastic resin having a softening point or a melting point exceeding 41° C. and by dispersing 700 parts by weight of carbon per 100 parts by weight of resin.

In addition, a carbon fiber nonwoven fabric was used as the electrode 122.

The appearance of the bipolar plate 13 of a portion to be brought into contact with the electrode 122 was morphologically matched with and the appearance of the electrode 122 by bringing the electrode 122, which is the carbon fiber nonwoven fabric, into close contact with the bipolar plate 13, generating Joule's heat by applying an electric current to the bipolar plate 13 (in this case, the electric current was 1.1-100 times higher than the current capacity of a typical battery), and applying a mechanical pressure of 5 kPa or higher, and a contact resistance between the bipolar 13 and the electrode 122 was measured.

### Comparison Example 1

An experiment was conducted under the same condition as in Example 1 except that matching between the bipolar plate 13 and the electrode 122 was performed by bringing the electrode 122, which is the carbon fiber nonwoven fabric, into close contact with the bipolar plate 13, generating Joule's heat by applying an electric current to the bipolar plate 13, and applying a mechanical pressure.

As a result of comparing the obtained contact resistances, the contact resistance of Example 1 was reduced by 30% or more in comparison to the contact resistance of Comparison Example 1, and it could be seen that the contact resistance in Example 1 according to at least one embodiment, in which the bipolar plate 13 and the electrode 122 were morphologically matched with each other, was lower than the contact resistance in Comparison Example 1.

### Example 2

The bipolar plate 13 was manufactured by using a thermoplastic resin having a softening point or a melting point exceeding 41° C. and by dispersing 700 parts by weight of carbon per 100 parts by weight of resin.

In addition, a carbon fiber nonwoven fabric was used as the electrode 122.

Unlike in Example 1, a stack in which the bipolar plat 13, the electrode 122, and an ion-exchange membrane 121 were assembled was prepared. Since the stack was in an assembled state, the bipolar plate 13 and the electrode 122 were compressed under a predetermined pressure. In addition, a side surface of the bipolar plate 13 was exposed from a side surface of the stack. Therefore, by connecting a separate power source to the electrode 122 through the exposed portion and generating Joule's heat by applying an electric current (in this case, the electric current was 1.1-100 times higher than the current capacity of a typical battery), the appearance of the bipolar plate 13 was morphologically matched with the appearance of the electrode 122, and a contact resistance between the bipolar plate 13 and the electrode 122 was measured.

### Comparison Example 2

An experiment was conducted under the same condition as in Example 1 except that matching between the bipolar plate 13 and the electrode 122 was performed by bringing the electrode 122, which is the carbon fiber nonwoven fabric, into close contact with the bipolar plate 13, generating Joule's heat by applying an electric current to the bipolar plate 13, and applying a mechanical pressure.

As a result of comparing the obtained contact resistances, the contact resistance of Example 1 was reduced by 30% or more in comparison to the contact resistance of Comparison Example 1, and it could be seen that the contact resistance in Example 1 according to at least one embodiment, in which the bipolar plate 13 and the electrode 122 were morphologically matched with each other, was lower than the contact resistance in Comparison Example 1. Unlike in Example 1, in Example 2, it could be seen that assembly efficiency was enhanced by matching the bipolar plate and the electrode in the assembled state of the stack.

According to at least one embodiment, there is an advantage that charging and discharging efficiency of a battery can be enhanced by reducing a contact resistance between an electrode and a bipolar plate.

In addition, the contact resistance can be reduced without losing mechanical material properties and thus the reliability of the battery can be enhanced.

Although the present disclosure has been described with various embodiments, various changes and modifications may be suggested to one skilled in the art. It is intended that the various embodiments encompass such changes and modifications as fall within the scope of the appended claims.

Reference numerals in figures:

| | |
|---|---|
| 10: stack | 11: unit cell |
| 12: membrane-electrode assembly | 13: bipolar plate |
| 14: frame | 20: anode reactant storage tank |
| 30: cathode reactant storage tank | 121: ion-exchange membrane |
| 122: electrode | |

What is claimed is:

1. A bipolar plate for a battery, comprising:
a thermoplastic portion formed on at least a part thereof to be brought into contact with an electrode and having conductivity,
wherein the thermoplastic portion having the conductivity is morphologically matched with the electrode, such that the bipolar plate and the electrode have shapes to be matched with each other in appearance.

2. A stack, comprising:
at least one unit cell, comprising the bipolar plate of claim 1, wherein the bipolar plate comprises the thermoplastic portion formed on the at least a part thereof to be brought into contact with the electrode and having the conductivity, and wherein the electrode is to be brought into contact with the bipolar plate, is stacked and assembled, and the thermoplastic portion is morphologically matched with the electrode by applying an electric current to the bipolar plate in the assembled state.

3. The bipolar plate of claim 1, wherein the thermoplastic portion having the conductivity is a resin comprising a conductive material.

4. The bipolar plate of claim 3, wherein the resin is a thermoplastic resin having a softening point or a melting point of 41° C. or higher.

5. The bipolar plate of claim 1, wherein the bipolar plate comprises only the thermoplastic portion having the conductivity.

6. The bipolar plate of claim 1, wherein the bipolar plate is formed of a plate and further comprises a plate-type thermoplastic portion having conductivity.

7. The bipolar plate of claim 6, wherein the plate is a conductive plate.

8. The bipolar plate of claim 7, wherein the conductive plate is a metal plate.

9. The bipolar plate of claim 1, wherein the electrode is formed of a porous material.

10. The bipolar plate of claim 9, wherein the electrode is a non-woven fabric of a conductive fiber.

11. A redox flow battery or a fuel cell, comprising:
a plurality of bipolar plates, each of which comprises a thermoplastic portion formed on at least a part thereof to be brought into contact with an electrode, and having conductivity, the thermoplastic portion having the conductivity being morphologically matched with the electrode;
a plurality of electrodes, which are interposed between the bipolar plates and fixed;
an electrolyte which passes through the electrode; and
a membrane which is interposed between the electrodes to allow ions to pass therethrough.

12. The bipolar plate of claim 1, wherein the bipolar plate is formed by impregnating a porous conductive material with a thermoplastic resin.

13. The bipolar plate of claim 12, wherein the porous conductive material forms a porous conductive structure by compressing metal powder under a predetermined pressure or compressing carbon (or graphite) powder under a predetermined pressure, or forms by using activated carbon.
